(19) United States
(12) Patent Application Publication
(10) Pub. No.: US 2003/0142809 A1
(43) Pub. Date: Jul. 31, 2003

(54) Apparatus, methods and articles of manufacture for computerized messaging control

(75) Inventor: Thomas J. Coffey, Lansdale, PA (US)

Correspondence Address: DILWORTH PAXSON LLP, 1735 Market Street, Philadelphia, PA, 19103, US

(73) Assignee: CallFx, Inc., Wilmington, DE

(21) Appl. No.: 10/057,555

(22) Filed: Jan. 25, 2002

(51) Int. Cl. H04M 3/00

(52) U.S. Cl. 379/265.01

(57) ABSTRACT

The present invention comprises apparatus, methods and articles of manufacture for automating the process of messaging. Preferred embodiments automate program flow construction for telephone calls which, in turn, create individualized scripts. The embodiments further permit construction of program flows by a caller over an interactive interface.

The present invention is directed to apparatus, methods and articles of manufacture for computerized telephone control. More particularly, the present invention is directed to apparatus, methods and articles of manufacture for computerized telephone control using networked computers.

### COPYRIGHT RIGHTS

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

While the telephone is an effective tool for individual or one-to-one communication, it is less than effective for broadcast, i.e., one-to-many or many-to-many communication. The telephone system requires that the caller connect with each call recipient, a process that can rapidly become inefficient in broadcast communication. Yet the individualized nature of a phone call may be very desirable from a business perspective. Thus, various procedures are available which attempt to make broadcast telephonic communication more efficient. These procedures may be manual, e.g., using banks of people to make calls, or automatic, e.g., using machinery to make calls. Most often a combination of manual and automatic procedures are used to make broadcast calls. So, for example, one common method of making broadcast calls is to use automated phone dialers. Automated dialers dial the phone and notify an operator when the connection is made, that is, when the automated dialer determines that a recipient is reached. These system hands over the call to a live operator will actually talk to the recipient. Usually, the operator's conversation proceeds according to a script generated by the caller.

There are both technical and operational difficulties with this process. The technical difficulties include the hand over process. For example, an automated dialer may incorrectly hand over the call to an operator if an answering machine rather than a recipient is reached, because the operator cannot engage in his script with a machine. As another example, technical difficulties may arise when the caller provides the telephone numbers for the broadcast call. An automated dialer may require that each number be entered individually thus saving little if any time over manual dialing. As yet another example, broadcast calling usually requires the caller to install complex and expensive equipment.

In order to attempt to overcome some of these difficulties, a caller may use a call center, which may have greater expertise in broadcast calling than the caller. Typically, the caller supplies a list of phone numbers to the call center. The call center provides the automated dialing and the hand over may be to the call center's operators or the caller's own. The caller may use the call center's operators or his own. Using the call center's operators might be more efficient and reduce technical issues involved in a hand over to the caller's live operators, however, a call center is more expensive and the call's center operators might be less than knowledgeable about the caller's business.

Even if a call center is used, and technical issues such as hand over and phone number transfers are resolved, a caller might still not be effectively using broadcast calling. Effective use of broadcast calling requires effective program flow or call structure. Constructing effective, particularized program flows must take into account the specific business purpose for making the call. Different businesses require different program flows. For example, a magazine subscription renewal broadcast call might have quite a different program flow than a car service reminders call. Yet there are few, if any, processes for simply and effectively constructing program flows, or modifying those flows for different businesses.

Constructing program flow is not a manner of simply entering phone numbers and reading from a script. Rather, program flows should be interactive, using automated mechanisms where most beneficial, such as allowing recipient interaction with a menu in order to best direct a call, allowing an operator to choose various options for forwarding a call, etc., yet, again, there are few, if any, systems permitting sophisticated program flow construction for broadcast calls.

Any such sophisticated program flow construction should also include the ability to provide specific, individualized attention to each recipient of the call. Sophisticated program flow construction should result in different scripts for different business lines, as mentioned above, as well as different scripts for different recipients within those business lines. For example, a business offering credit may have an entirely different script for a creditworthy customer than for a credit risky customer, and there are few, if any, systems permitting specific, individualized scripting for particular recipients.

The need for simple and effective systems to construct sophisticated program flows in broadcast calls is manifest.

Accordingly, it is an object of the present invention to simply and effectively automate the process of making telephone calls.

It is a further object of the present invention to provide callers with the ability to simply and effectively automate the process of making telephone calls.

It is a further object of the present invention to provide callers with the ability to simply and effectively automate the process of making telephone calls, including automating program flow construction for broadcast calls.

It is yet a further object of the present invention to provide callers with the ability to construct scripts that provide specific, individualized attention to each recipient of the call.

It is yet a further object of the present invention to provide callers with the ability to simply and efficiently automate the process of making telephone calls, including the ability to construct program flow with individualized recipient scripts, over the Internet.

### SUMMARY OF THE INVENTION

The present invention comprises apparatus, methods and articles of manufacture for automating the process of making telephone calls. Preferred embodiments automate program flow construction for broadcast calls and especially preferred embodiments provide users with the ability to construct program flow with individualized scripts. The embodiments further permit construction of program flows by a caller over an Internet connection.

In the preferred embodiments, a caller connects to an application server through a network connection. Using a graphic user interface, the caller establishes a program flow. The system offers the user a number of alternative processes for constructing program flow. The alternative processes range from a simple process allowing the user to quickly produce a simple program flow to an advanced process allowing the user to produce complex program flows.

Once a program flow is constructed by the user, call scripts are generated by the server. The scripts may include interactive processes selected by the user that will alter the flow of a call in progress. For example, the user may have drafted a script that provides alternatives to the recipient at any point, such as choosing 1 on the number pad for a certain action, 2 for another action, etc.

The embodiments further permit the user to provide other desired variables in order to make the broadcast calls. For example, the caller may provide the desired time of day to make calls, number of times to let the phone ring before terminating a calling attempt, etc. Telephone numbers may be manually provided by the user or uploaded as desired.

Once the user has prepared the program flow, and provided any other desired variables for the calls, the server stores the information. When appropriate, the server transfers the information to a real time call server which proceeds to control the telephony equipment making the calls according to the entered variables. Both application server and call server are, in the preferred embodiments, linked through numerous processes. For example the application server constructs a number of tables containing call parameters which are then transmitted to a call server.

The call server follows whatever program flow the user has provided in making the calls. For example, various scripts may have been generated for various types of callers as mentioned above, various calling technologies such as an automated voice response unit, a live operator, call transfer, synthesized speech or any of a number of other methods to communicate with the call recipient may have been specified by the user, etc. One especially preferred embodiment uses, at least in part, text to speech technology wherein the user enters text during the process of constructing program flow which is then read to the call recipient through a text to speech module. Another especially preferred embodiment uses voice recognition, so that the recipient may respond verbally rather than, or in addition to, other response means, such as keypad response, voice printing, etc.

Other options for scripting in the preferred embodiments include flexible hand overs or call diversion. For example, the user may desire to have calls flexibly routed to a live operator, for example, such as only routing calls where the recipient has chosen certain options, e.g., pressing a number to indicate further interest. As another example, the user may desire to increase or limit, (throttle up or throttle down) the blast pace through manual or automatic mechanisms, for example, reducing the outgoing calls of the blast during certain hours, limiting incoming recipient responses to a user phone number if that phone number is in use, etc. Throttling up or down might occur through an adaptive algorithm, user control, etc. As yet another example, calls may be diverted to the caller with identifying information, so that, for example, upon receiving the notice a call has been diverted to him, and viewing identifying information about the recipient, the caller might further divert a call, etc.

At the end of the call, the preferred embodiments maintain records of the call, including time called, success of the call (that is, if a recipient was or was not reached), etc. These records may be then disseminated back to the caller and may be used to refine program flow, calling variables, call script, etc.

### BRIEF DESCRIPTION OF THE DRAWINGS

FIG. 1 is a schematic view of a preferred embodiment.

FIG. 2 is a screen shot of a preferred embodiment.

FIG. 3 is a screen shot of a preferred embodiment.

FIG. 4 is a screen shot of a preferred embodiment.

FIG. 5 is a screen shot of a preferred embodiment.

FIG. 6 is a screen shot of a preferred embodiment.

FIG. 7 is a screen shot of a preferred embodiment.

FIG. 8 is a screen shot of a preferred embodiment.

FIG. 9 is a screen shot of a preferred embodiment.

FIG. 10 is a screen shot of a preferred embodiment.

FIG. 11 is a screen shot of a preferred embodiment.

FIG. 12 is a screen shot of a preferred embodiment.

FIG. 13 is a screen shot of a preferred embodiment.

FIG. 14 is a screen shot of a preferred embodiment.

FIG. 15 is a screen shot of a preferred embodiment.

FIG. 16 is a screen shot of a preferred embodiment.

FIG. 17 is a screen shot of a preferred embodiment.

FIG. 18 is a screen shot of a preferred embodiment.

FIG. 19 is a screen shot of a preferred embodiment.

### DETAILED DESCRIPTION OF THE PREFERRED EMBODIMENTS

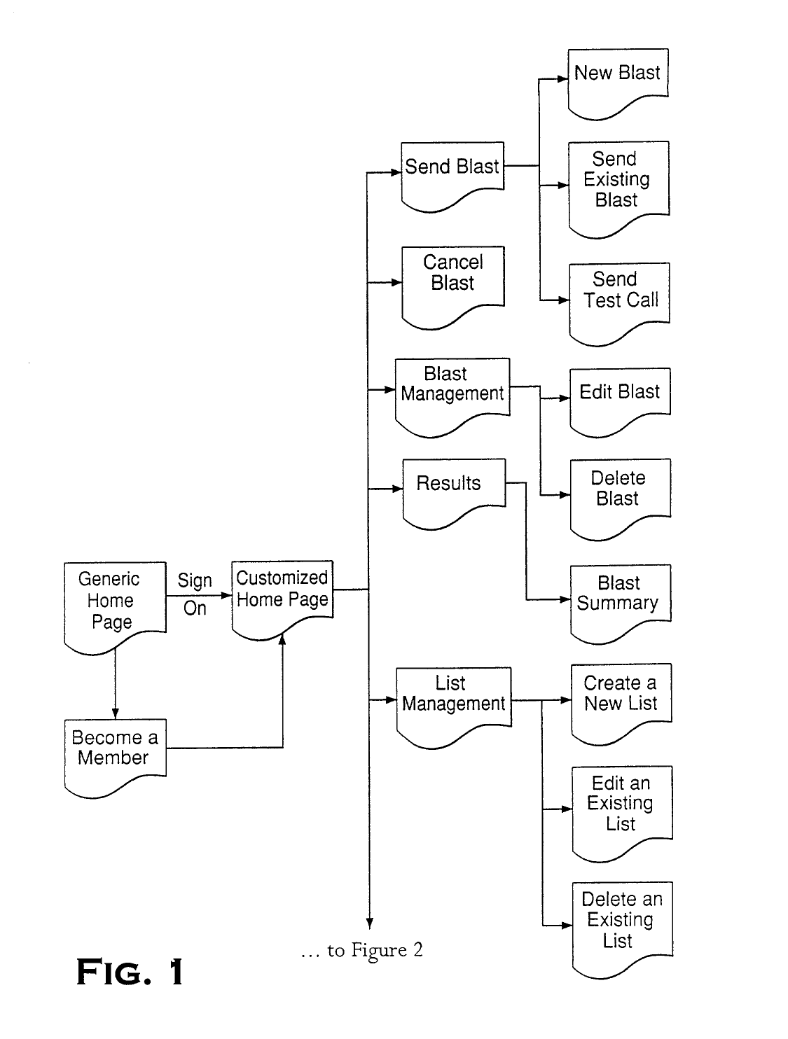

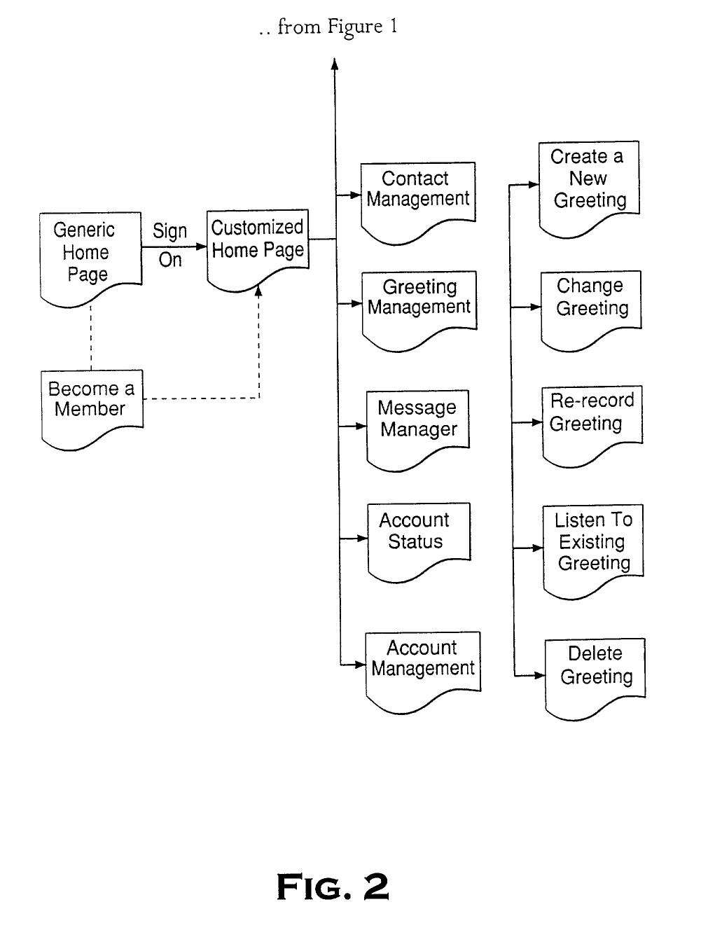

FIGS. 1 and 2 shows a summary flow through a preferred embodiment with a Website interface. Other embodiments may use other types of interactive interfaces known in the art. In the preferred embodiment of FIGS. 1 and 2, the caller is initially presented with a generic homepage on the Website of the blast provider. The term “blast provider” is used herein to designate the entity providing the ability to construct the blast script, as well as actually conduct the blast (which word, as used herein, means a series of telephone calls. It should be noted that “series” means one as well as only more than one, and does not only mean sequential, but may be taken to mean simultaneous as well, so, for example, multiple calls may be made simultaneously as the word series is herein defined.) It should be noted, however, that in other embodiments, there may be no blast provider, e.g., the user may construct a script entirely on his own system or systems, conduct a blast through an alternative provider, etc.

Returning to FIGS. 1 and 2, a caller may sign on to a customized home page or, alternatively in a manner not shown in the Figures, be directed to a customized home page, such as through cookies or other methods known in the art.

Once the caller has logged onto the system, she is presented with a number of options. Proceeding from the top down in FIG. 1, those options are:

Send Blast. A blast is a term used herein for a series of calls, which can be any number, e.g., one call, broadcast calling to more than one number, etc. Sub-options available in this embodiment under the Send Blast option are;

New Blast. This provides a caller with the option to construct the program flow that will be used prepare scripts and conduct a blast;

Edit Blast. This provides the user with the option to edit an existing blast;

Send a Test Call. This provides the user with the option to test a blast by sending a test call to a designated number. Once the number is called, the script is performed upon the test recipient.

Cancel Blast. This provides the user with the option to cancel an active blast.

Results. This provides the user with the option to review the results of an active or completed blast. A Blast Summary is offered as a sub-option.

List Management. This provides uploading, editing, creating and other tools for the list of recipients of a blast. Sub-options available in this embodiment under the List Management option are:

Create a New List. This provides a caller with the option to create and use and/or store a recipient list;

Edit an Existing List. This provides a caller with the option to edit and use and/or store an existing recipient list;

Delete an Existing List. This provides a caller with the option to delete an existing recipient list.

Continuing to FIG. 2, the options are:

Contact Management. This provides uploading, editing, creating and other tools for the caller's contact list, which is comprised of all recipient lists, as well as any other entries the caller wishes to make.

Greeting Management. This provides access to the greeting screens which are usually used in a call. Sub-options available in this embodiment under the Greeting Management option are:

Create a New Greeting. This provides a caller with the option to create and use and/or store a greeting;

Change Greeting. This provides a caller with the option to change the name and/or description of an existing greeting;

Re-record Greeting. This provides a caller with the option to re-record an existing greeting.

Listen to an Existing Greeting. This provides a caller with the option to listen to an existing greeting over the interface.

Delete Greeting. This provides a caller with the option to delete an existing greeting.

Message Manager. This provides management of messages that may be left by recipients in the course of the call. Specific messages may be left in specific caller voice mail accounts.

Account Status. This provides access to the caller's account.

Account Management. This provides caller configurable preferences for billing, account management, etc.

It should be noted that these options are those available in this embodiment, and other embodiments may offer a modified group of options, other options, etc.

The graphic user interface used in the especially preferred embodiments will now be described. Again, it should be noted that in other embodiments, other interfaces may be used. Moreover, in the especially preferred embodiments the users access the server through a web browser interface, and so the description of those embodiments uses Web terminology. However, it should be specifically understood that embodiments can be implemented in environments that support GUI and other interfaces, including but not limited to Microsoft Windows® NT, Windows® 2000, Windows® 95, 98 and Me, Unix® and Unix®-like platforms, including but not limited to Linux® and its variants, as well as other operating system platforms including but not limited to IBM OS/390, MacOS, VxWorks® and others.

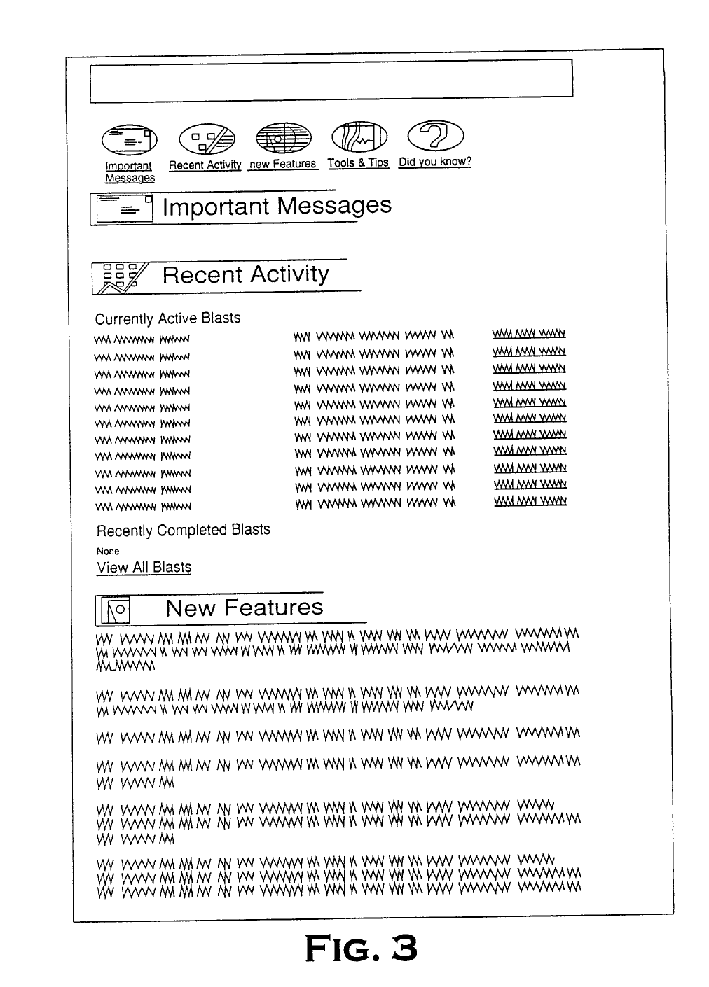

Turning to FIG. 3 an example of a customized home page interface is seen. The user is presented with an Important Messages section, comprising particular messages for her, as well as a Recent Activity section, where recent blasts are shown in summary fashion. Each of these recent blasts may be grouped under a heading indicating their status. For example, Currently Active Blasts are grouped in one area, Recently Completed Blasts are grouped in another area and All Blasts may be viewed in another screen. Each blast is identified by name and relevant date. Further details of the blast may be also available. New Features, Tools and Tips, and Did You Know sections provides the User with general system news and information.

Creating a blast comprises, at least partially, constructing a program flow, providing a list of recipients of the blast, and optionally, providing a greeting.

Program flow provides the call structure, e.g., questions to ask recipients, alternative paths depending upon responses, etc. In the especially preferred embodiments, a user may construct a program flow in a number of ways, from simple question and answer sessions to more complex custom sessions as is further described below. The construction of a program flow provides a script for the calls made in the blast. Each call in the blast is made according to the script, however, the actual calls made may have different content. The actual calls made may have different content because the script may, in more sophisticated blasts, provide for interactive call pace and progression which will be described further below.

In various especially preferred embodiments, two general levels of program flow are offered to the user: a simple level and an advanced level. Each level provides a number of options for constructing the program. The simplest level provides the fewest options and, accordingly, a simple program flow is constructed leading to a simple script. Essentially a caller is filling in values within an application in a question and answer format that is then used by the system to place the calls. For example, a simple option might be used to construct an opinion poll blast, a sale offer blast, etc. The advanced level provides the most options for constructing program flow, including direct customization or authoring of a script or scripts if desired. A graphic user interface with call component blocks to be assembled as desired by the user might be offered on an advanced interface. Alternatively, other interfaces such as a scripting type language interface might be used, other graphic user interfaces with more sophisticated question and answer options than seen in the simple option, etc. The advanced option, in certain embodiments, also permits the caller to construct a new application to place calls. For example, using an advanced option to construct a script might result in an interactive voice based blast, through a text to speech call with voice recognition response, etc.

The components of a blast, e.g. a particular text-to-speech message, might be stored for later reuse. For example, while constructing a script, a user might also reuse components, such as a particular text to speech message. A user might also store and/or reuse modules, such as a particular program flow through part of a script. Scripts may also be stored and reused, as well as shared among users. In some embodiments, scripts may be categorized by subject or any other criteria in order to simplify reuse.

Alternative options for the script are most pronounced in the advanced level. Additionally, the advanced level may include a number of text to speech components of a script, which result in a more individualized call within the blast. Other embodiments may have greater or fewer levels, as well as differing components from the levels of the preferred embodiments.

Various levels may be chosen by the caller for any number of reasons. For example, a business may use a simple level when constructing a program flow designed to only leave a message on an answering machine. The advanced level may be used when the caller chooses to present the recipients with a number of options or a more sophisticated call presentation, such as would be accomplished through preparing or uploading messages to be delivered during the course of the call by way of a text to speech module. The advanced level may also provide greater ability to manipulate other call parameters, for example, changing the pace of the blast, identifying the caller ID as coming from an other entity than the blast provider, e.g. the caller.

The use of the various levels also results in lesser or greater customization of the call. Greater customization permits different recipients to be addressed differently, such as when a business desires to make different offers to different types of customers. This is accomplished by constructing the program flow so as to provide a greater set of alternatives to be presented to the recipient during the call.

Program flow is usually constructed in this embodiment by the caller first choosing the option to Send Blast in FIG. 1 followed by the sub-option New Blast. In this embodiment, depending on the options chosen, as will be further described below, the caller will be constructing the flow at a simple or advanced level. The caller is not limited to this particular navigation scheme in this embodiment. Alternative navigation is possible as well in this and other embodiments.

Additionally, in this and other embodiments the caller does not have to construct program flow by beginning anew. For example, templates may be offered as guidelines for program flow construction. A template might be offered for a newspaper classified ad blast, another might be a brokerage firm program, etc. These templates could then be modified, or not, as desired. Additionally, as will be further described below, program flow may be constructed by reusing a blast, using a preconstructed blast, etc. Additionally, program flows, scripts, lists and other information can be shared among callers as desired.

As is described further below, creating a blast also requires, in this embodiment, identifying a list of recipients of the blast. A list of recipients may be uploaded to the server using methods known in the art. Alternatively, a list may be modified or created on the Web site interface. A list may also be reused, that is more than one blast may use an existing list, an existing list may be modified for a new blast, etc.

Also as described further below, this embodiment provides the option to include a greeting in the blast. This greeting would begin the script, that is, it would be the first thing the recipient would hear. A greeting may be used on more than one blast, if desired. A greeting may be created for a blast or reused or modified from an existing greeting.

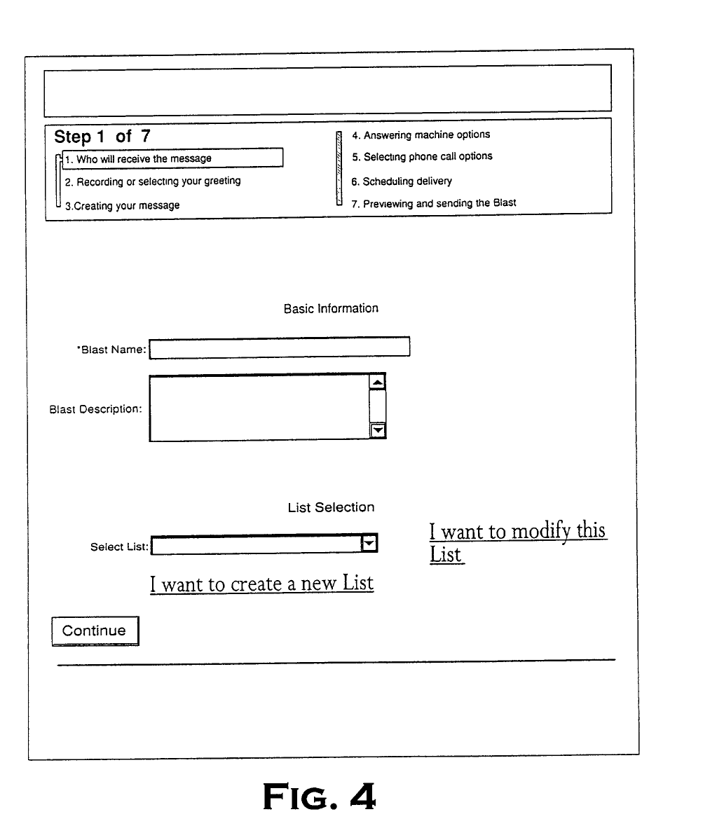

FIG. 4 shows an example of a Set Up Screen for creating a blast. In this embodiment, this begins the construction of program flow. As can be seen by the Figure, options are provided for naming the blast, describing the blast and using either a predetermined list of call recipients or creating a list of call recipients. If a predetermined list is chosen, a further option to modify the list is presented.

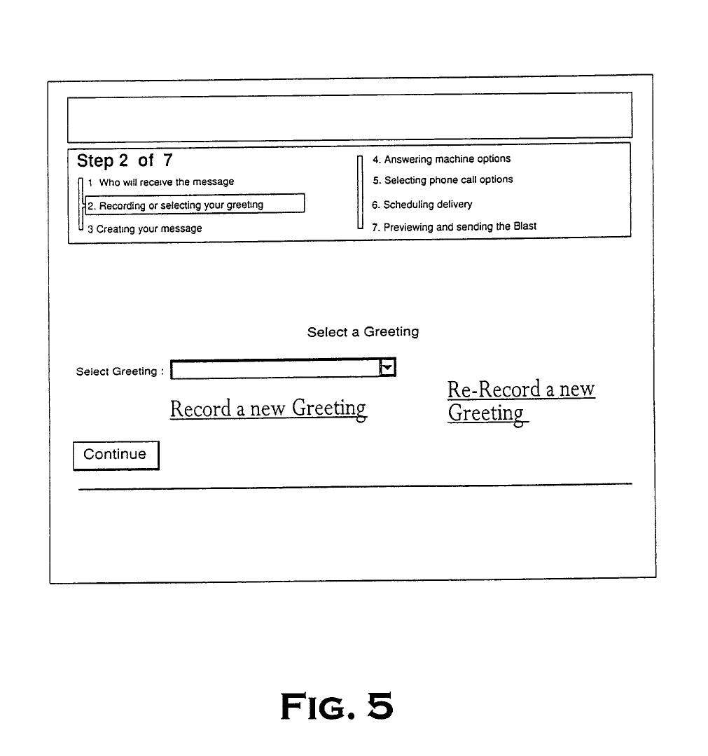

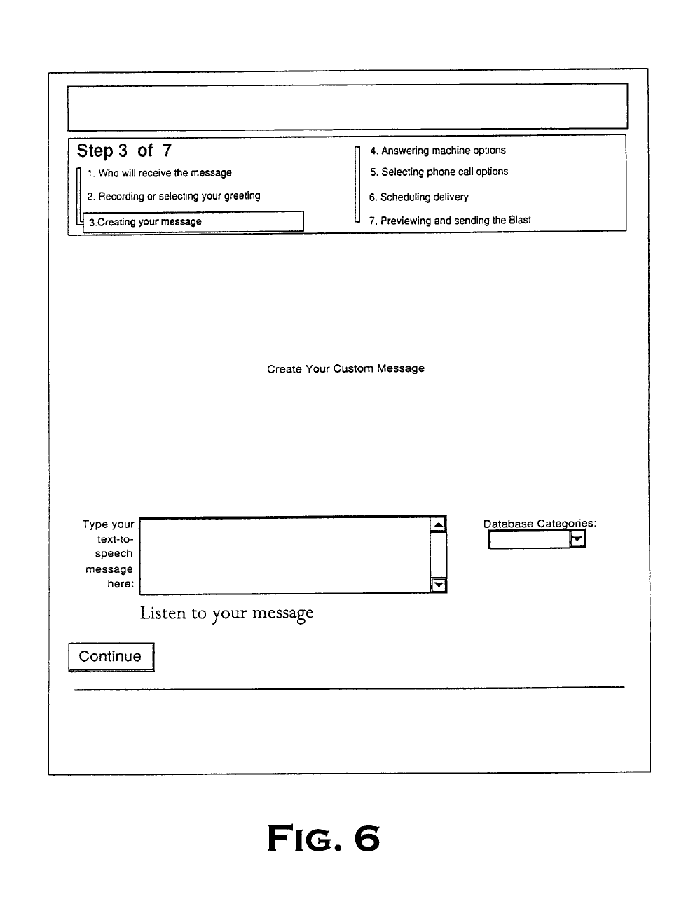

Turing now to FIG. 5, the User is provided with the option to select or record the Greeting for the call. The selection is made from a list of predetermined greetings. FIG. 6 shows a messaging screen, which provides the User with the ability to create a message to be added to the Greeting, if desired. The message may be customized in this embodiment, through merger of parameters matched with desired fields in a database of call recipients. For example, a message may be: You have an appointment on [1] in our [2] office. The fields 1 and 2 are the parameters to be looked up and replaced by the appropriate entries in the call database.

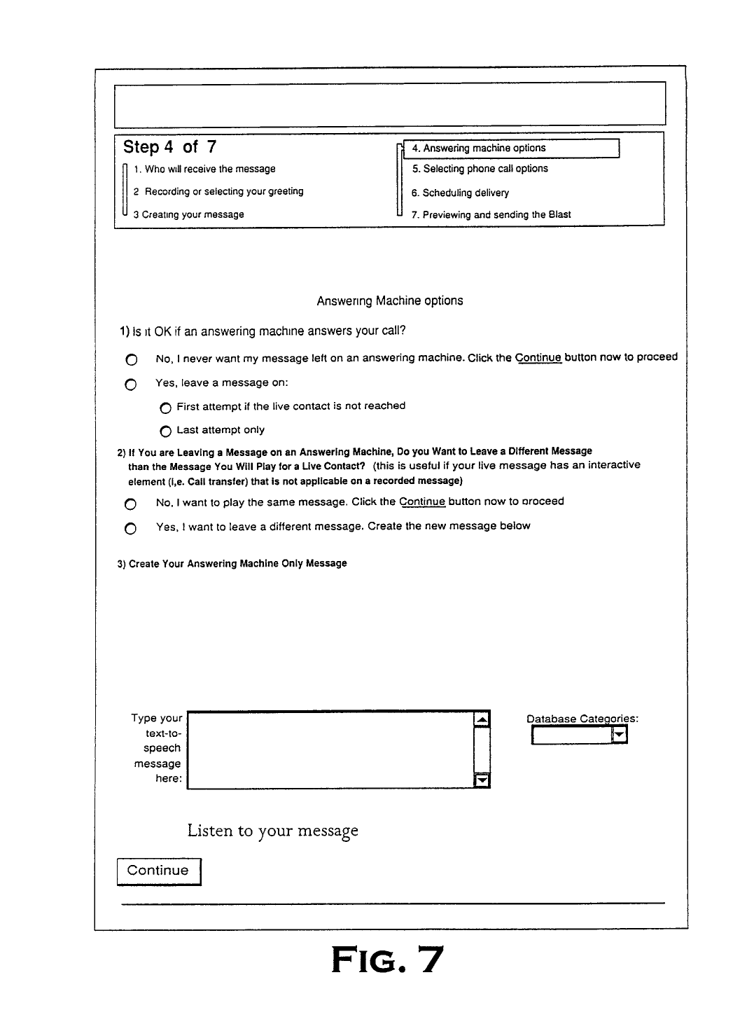

FIG. 7 shows options available for answering machine operation. This embodiment provides alternative responses when an answering machine (which is used herein as a term that includes any type of automated answering device) rather than a live recipient receives the call of the blast. In this embodiment, two options are available:

1) Do not leave a message if an answering machine answers;

2) Leave a message on either the first or last attempted call to the number.

If a message is left, the user can leave a different message on the answering machine than the message of the live blast, and the options for doing so are similar to the messaging options above. That is, a customized message may be left, through merger of parameters matched with desired fields in a database of call recipients. The message can be played back if desired to ensure it is satisfactory before proceeding with the blast.

Other embodiments might include options to leave messages on any specific call within the blast, such as the next to last call, message delivery only to an answering machine, etc.

Answering machines may be detected in a number of ways, such as through the beep tone or other signal, through pauses typically occurring in an answering machine, speech pattern used, sequence of events typically occurring when an answering machine answers, etc. This detection further provides flexibility in tailoring a message to a live recipient or an answering machine.

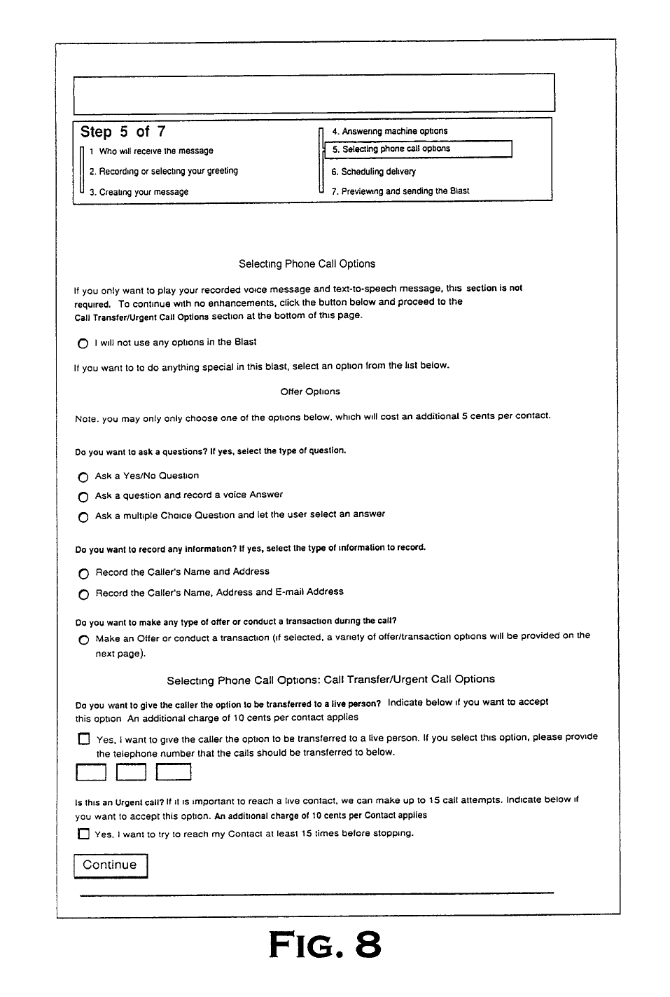

Additional options are offered as well. Turning to FIG. 8, the user may choose from a number of options including:

Ask a Yes/No Question of the Call Recipient;

Ask a Question and Record a Voice Answer;

Ask a Multiple-Choice Question and Provide User Selectable Answers;

Record User Information, such as Name, Address, Email Address;

Make an Offer to the Call recipient or Conduct a transaction with the Recipient;

Transfer to Live Operator;

Additional Call attempts.

The user, operating at the simplest level, may use none of these, which results in a “passive” message, usually being a recorded greeting plus a message, constructed through text to speech or from an audio recording. Of course, in other embodiments, these options may be offered in combination as desired, as well as other options, such as recording other information from the recipient, offering the call recipient the option to opt out of future blasts, etc.

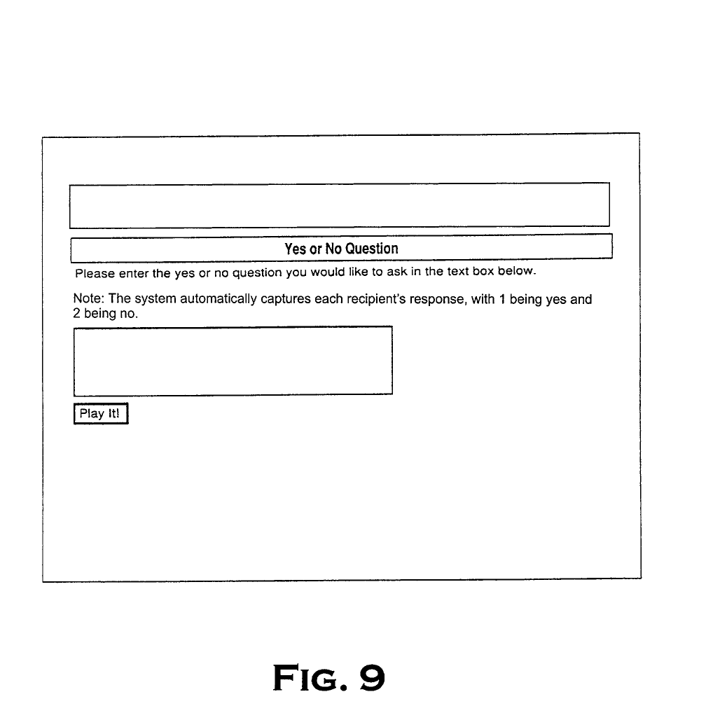

Turning briefly to FIG. 9 an example of an entry box for a Yes/No Question to be asked is shown. The entered question will be converted to speech by a text to speech module.

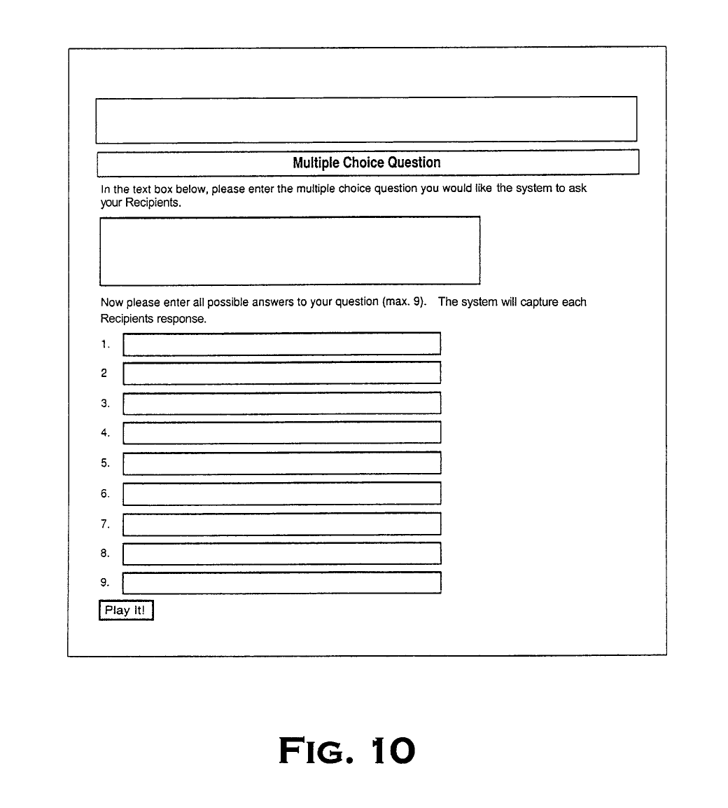

FIG. 10 shows an example of a “Multiple-Choice Question” option with space for the possible answers to be provided. Again the entry is read to the recipient by a text to speech module, if desired, by clicking the Play It button. One or more of the options might lead to a callback to the caller. In such a case, this might be offered on a dynamic or throttling basis, with the callback choice not offered if the caller's lines are in use, the time of the callback is inconvenient for the caller, etc.

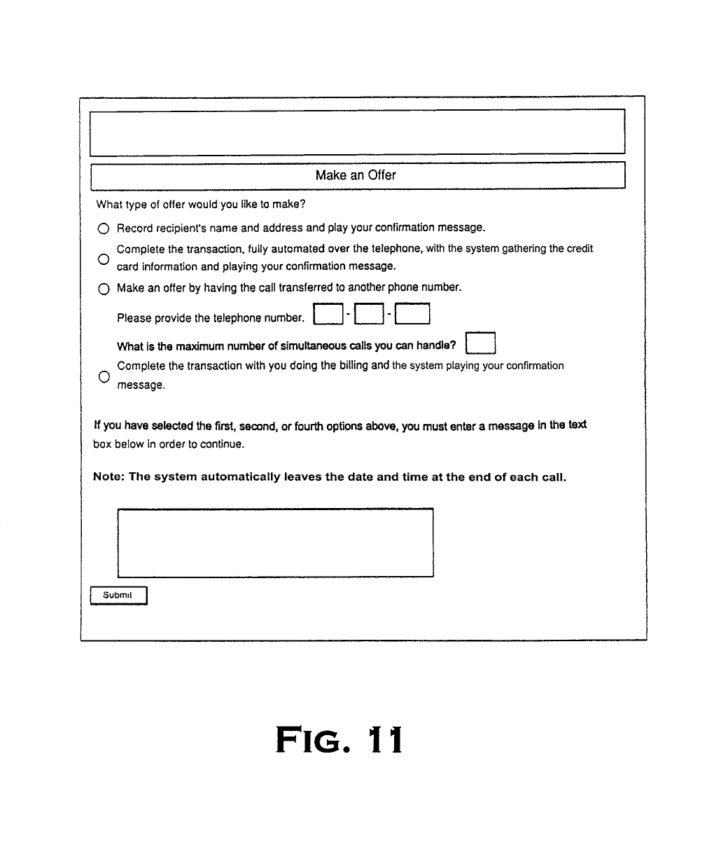

FIG. 11 shows an exemplary screen used for a “Make an Offer” option. Among the options of this embodiment, as shown by the Figure, are the option to automate a recipient's purchase utilizing credit card information supplied to the system by the recipient. Automated purchase might be especially useful in transaction renewal, such as where a recipient has purchased an item previously. In such an instance the recipient might be willing to automatically repurchase the item. The embodiment permits convenient automatic purchase, using stored credit card and/or other information, and could capture any additional recipient information to facilitate the purchase, such as the recipient's name, address and other relevant information. The information could be captured by the system in a number of ways known in the art, such as touch tone data entry, voice capture, voice recognition, etc.

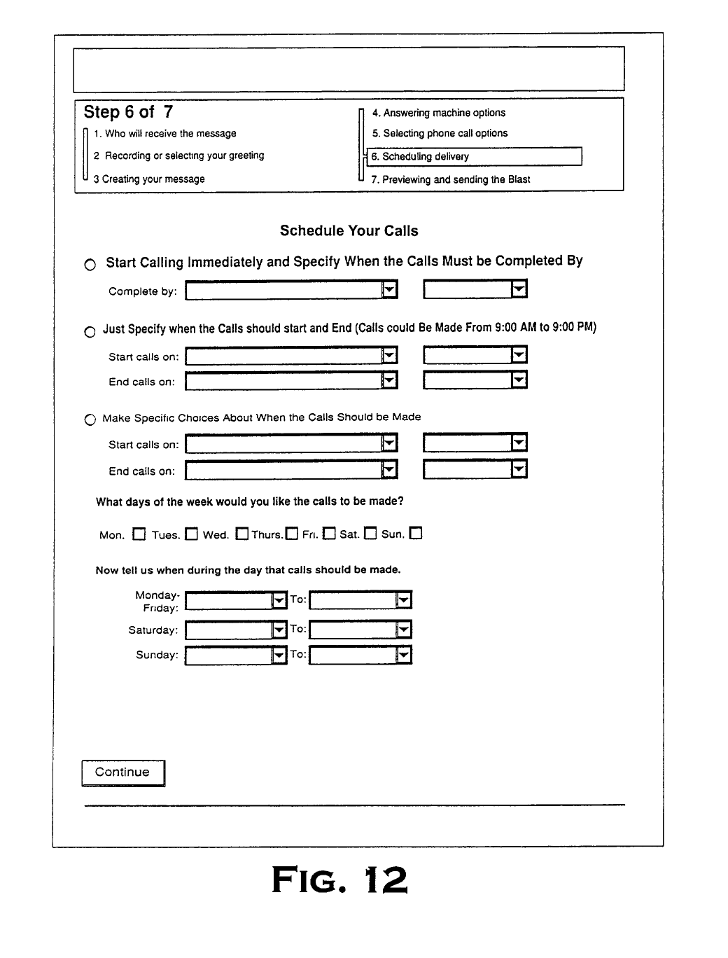

Scheduling is another step in constructing a blast in this embodiment. FIG. 12 shows a scheduling screen of this embodiment, used to schedule the calls of the blast. A number of options are available, such as specific start and stop dates, specific times, days of the week, etc.

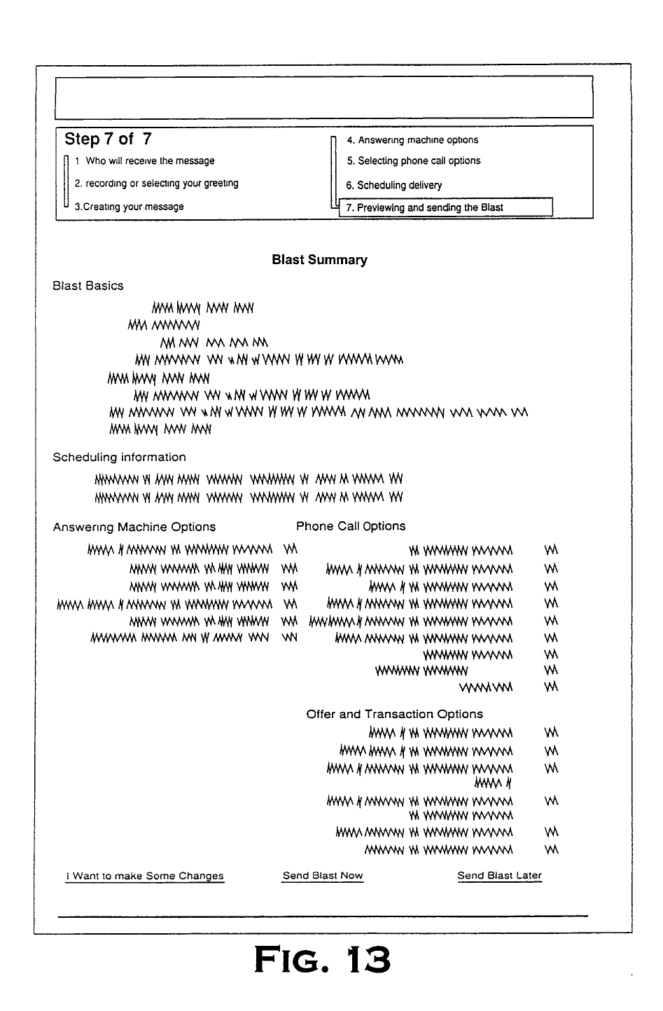

Once the scheduling is complete, this embodiment provides a review of the chosen options, see, e.g., FIG. 13. The User may change the options or send the blast immediately or when desired.

As was described above, specific steps may be followed in order when constructing a blast. It should be noted however, that any ordering of steps as set forth above with regard to the embodiments may be modified as desired in other embodiments. For example, the User may skip a “Phone Call Options” step. Moreover, in other embodiments, any step used in blast preparation may be added, deleted, and/or modified as desired.

Once a new blast has been constructed, it may be stored and repeated, on automatic or manual basis, if desired. For example, a recurring, automatic blast can be set at a desired periodicity. Additionally, a new blast may be constructed by reusing a blast, using a preconstructed blast, etc. The user might also desire to use a stored blast in order to relaunch a blast, reschedule a blast, modify and reschedule a blast, etc.

Returning to FIG. 1, the Editing option for blasts is seen. Editing can include modifying a blast that is being executed, for example, deciding only to make certain calls. Additionally, there are other options shown in the embodiment of FIG. 1 for altering the execution of a blast, such as pausing a blast, resuming a blast that is paused, and canceling a blast.

It should be noted that a program flow may be constructed to create nested blasts, or a blast within a blast. For example, a blast may in turn supply the ability to the recipient to construct a blast, such as a blast to a general contractor from a weather service when there is foul weather. The blast to the general contractor will provide him with the ability to, in turn, blast his sub contractors, so that he does not have to call each individually. These triggered or nested blasts may go on in series, and may themselves be edited or modified if desired. Triggers may be such variables as date, time, etc.

Other options for scripting a blast in the preferred embodiments include call diversion. For example, when a blast is occurring, one option is to transfer the call after reaching a live recipient to the caller or his designee. The transfer might include identifying information, e.g., Caller ID, cross referenced contact list information, recipient name, recipient telephone number, unique caller identifier for the recipient, etc. Once the caller has had the call diverted to him, he might, in turn, further divert a call, place the recipient into specific voice mail, speak to the recipient, etc. It should be noted that, in certain embodiments, call diversion might only occur under predetermined conditions, for example, diverting calls where the recipient has chosen certain options such as pressing a number to indicate further interest.

The user might also desire to alter the scheduling or pace of the blast. For example, “throttling down,” or reducing the pace of a blast might be desired, such as dynamically limiting the amount of responses that may be diverted to a live caller designee. If a caller designee is busy on a call, recipient calls might not be diverted to him, but rather would take an alternative path. Another example of throttling down might be limiting blast calls during lunch, odd hours, etc. Throttling up might also be desirable, for example, when a high response rate for limited offer is being received, etc.

Throttling up or down may be done manually or automatically. An example of a manual interaction might be when the user suddenly needs to limit a blast pace because he does not have resources available because of an unforeseen situation. An example of an automatic interaction might be an adaptive algorithm, which might, for example, throttle the blast pace down when an especially large number of recipients need individualized attention.

Blasts results can be tracked for any number of reasons. For example, the pace of a blast might be altered, as was described above, based on results from a blast as it progresses. Additionally, results of the blast may be reviewed as desired. This is a particularly useful element of this embodiment insofar as the caller can understand which recipients, techniques, and other variables provide the desired return.

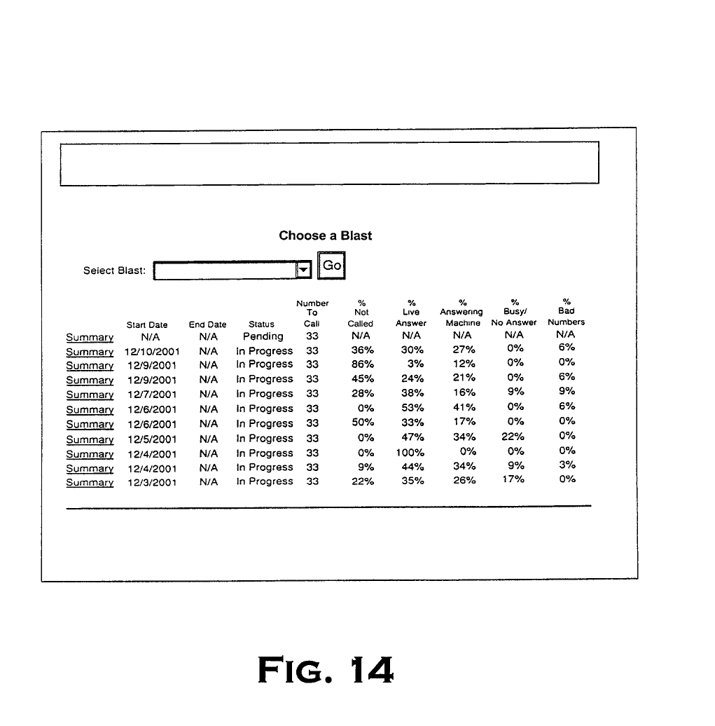

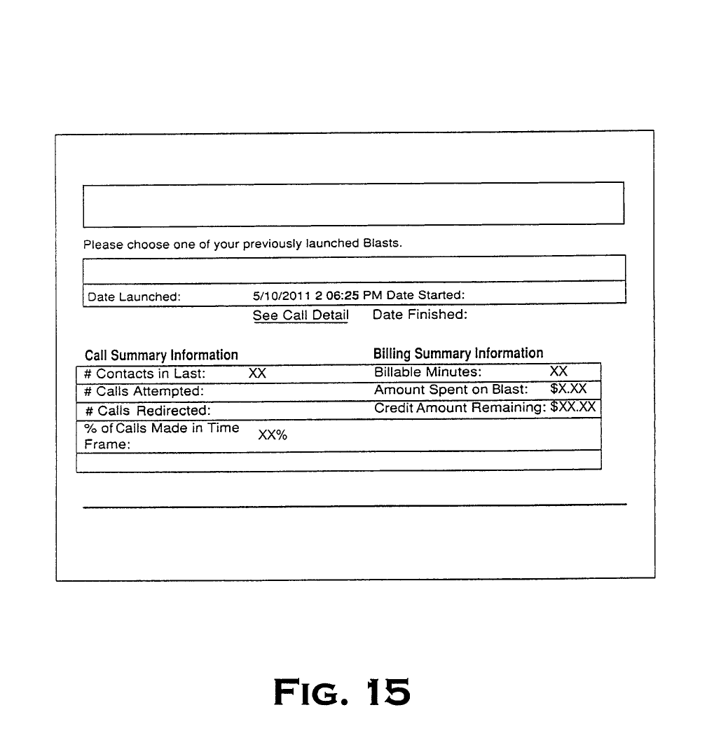

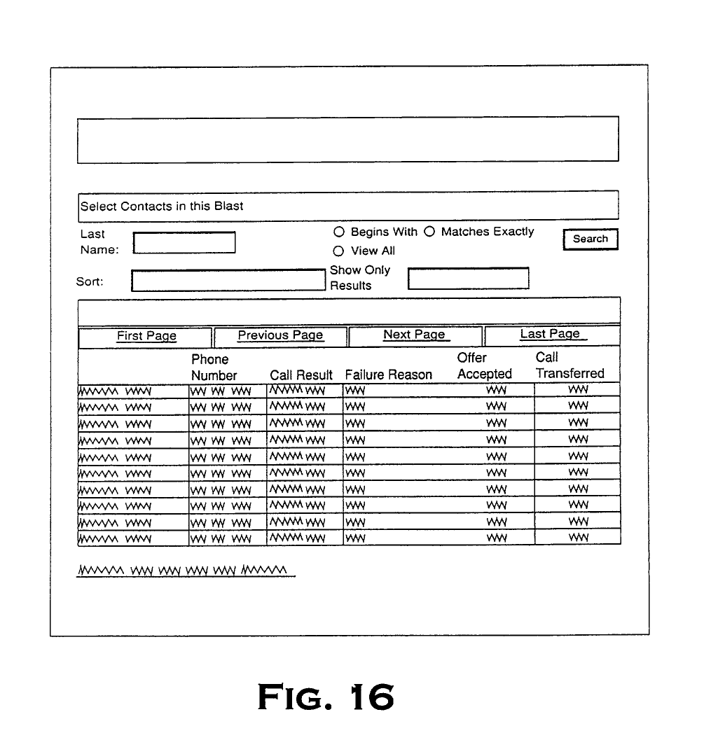

Shown in FIG. 14 is a Results screen. This screen provides a table of all blasts instances for the user. The user can select the particular blast she wishes to track. Once the blast is selected, a summary screen is shown in this embodiment. FIG. 15 shows one possible screen. The screen of the embodiment of FIG. 15 contains various call details, e.g., the recipient's number, the calls attempted, the dates started, etc. The user may configure the responses to any available level as desired. For example, the user might desire additional detail about the call, as shown by the example of FIG. 16. Here, the recipient's names, phone numbers, results, reasons for failure, offer acceptance, etc. are shown.

In other embodiments, detailed results may be presented in as much or as little detail as desired, including, for example, the name of the person who answered the phone, if different than the recipient listing, the time the recipient received the call, etc. In some embodiments, the recipient information recorded is that information which will permit greater success on a retry, such as the time recipient receives the call, how many calls were made to a recipient of the blast without a busy signal, live answer and/or answering machine response, number of calls made without reaching a live recipient, delivery confirmation, accepted offers, declined offers, summary of survey options selected by recipients, audio recordings or transcriptions of voice responses, etc.

Information about the blast, including any messages left by the recipient may be retrieved through a telephony interface as well as computer based interfaces, including but not limited to graphic user interfaces, email interfaces, etc. Additionally, the blast might be managed through other interfaces than a computer based interface, e.g. a telephone interface. So, for example, the caller might update his greeting, launch or pause a blast, review the status of blast, etc. through a telephone based interface.

The results of the call may be used in a number of ways. For example, in this embodiment, the results may establish another list of possible recipients, that is, if desired a new list may be created out of the results list. Creating a new list may be especially desirous when, for example, the displayed recipients match some search criteria as shown in the screen for example, search criteria such as successful calls, unsuccessful calls, sorted phone numbers, sorted by last names, etc. These new lists may then be reused, edited or otherwise modified as desired. In such a manner a new blast may be created from the results of the old blast by using the feedback of the old blast.

Returning now to FIG. 1, other options depending from the customized home page are shown. Of course, in other embodiments, the user interface may be different, that is, may be other than a home page, or may be a home page but have other options depending from the home page.

The List Management option seen at FIG. 1 permits uploading, editing creating and other tools for managing a recipient list or lists. The list may be a subset of contacts, as further described below, or may be the entire set of contacts. List creation and management usually comprises manipulating the contact list, for example, extracting certain desired recipients from the general contact list based on various criteria, e.g., choosing person from a high income neighborhood, based on ZIP code, to receive a blast. Lists may be also created or modified from blast results, may be presupplied, may be edited to eliminate duplicates, may be cleansed according to various criteria, etc. Tools for list management may be manual or automatic.

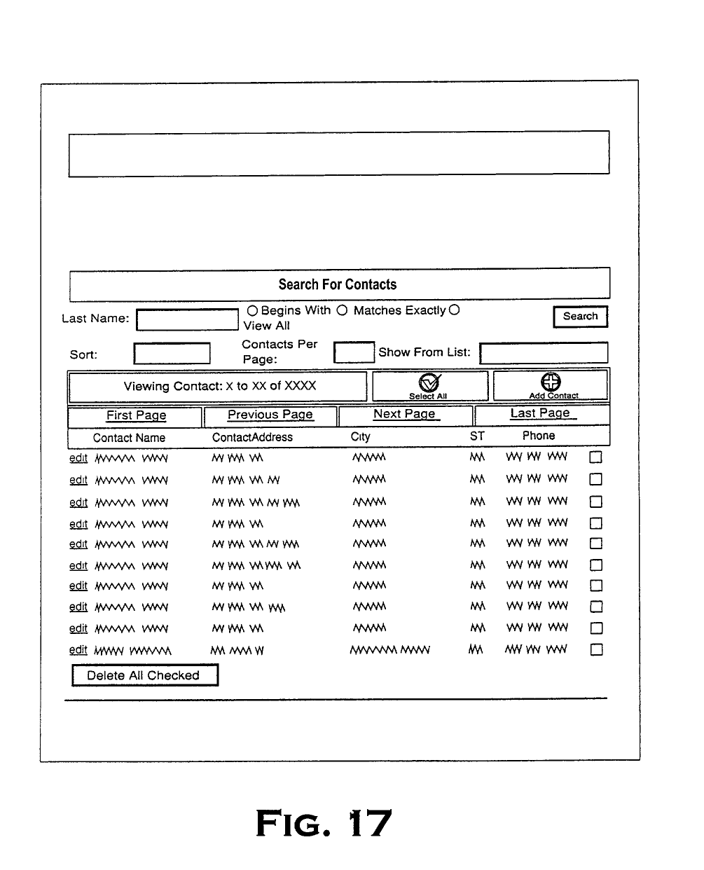

The Contact Management option seen at FIG. 2 permits uploading, editing, creating and other tools for managing a contact list. The contact list is, in the especially preferred embodiments, all recipients for all lists of the caller—a superset of recipients. The contact list may also contain other names of interest. Turning to FIG. 17 an example of a Contact Management screen is seen. This screen lists the user's contacts and may be sorted by last name or city, or in otherwise desirable categories, e.g. ZIP code. Contact lists may also include information about the contacts on the list, such as response details to any particular blast, contact response text transcribed from a particular blast, audio blast responses from contacts, cross reference to blast information that involved that particular contact, etc. Preferred embodiments might, as well, merge text to speech blast components with their responses, so the caller receives any particular call program flow. Responses can be merged as well, and a database constructed, so that a partial or complete blast record of responses is available to the user.

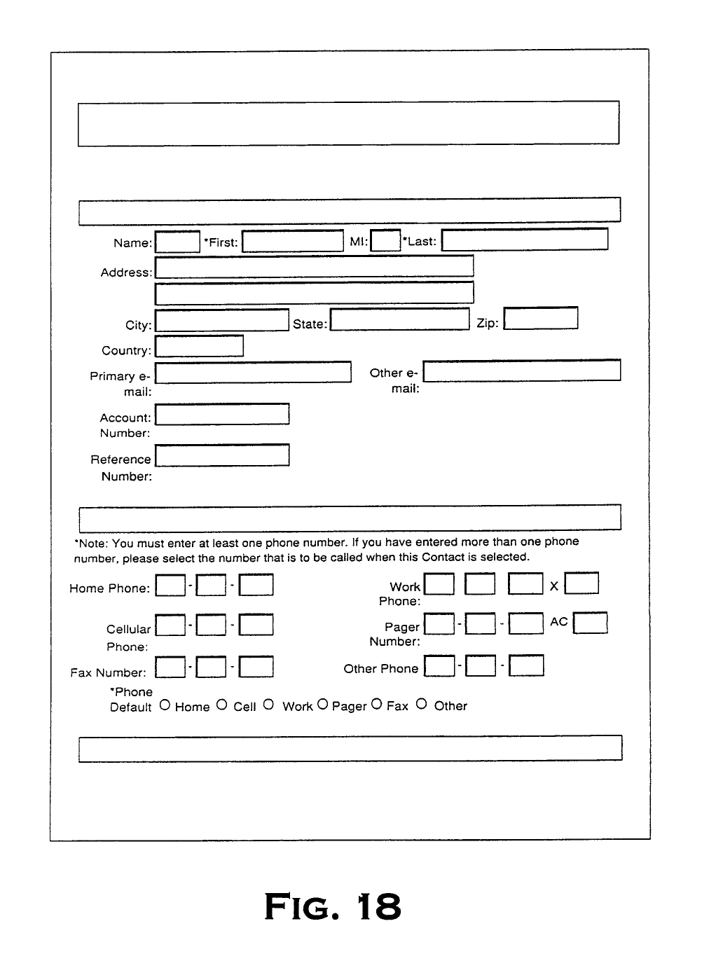

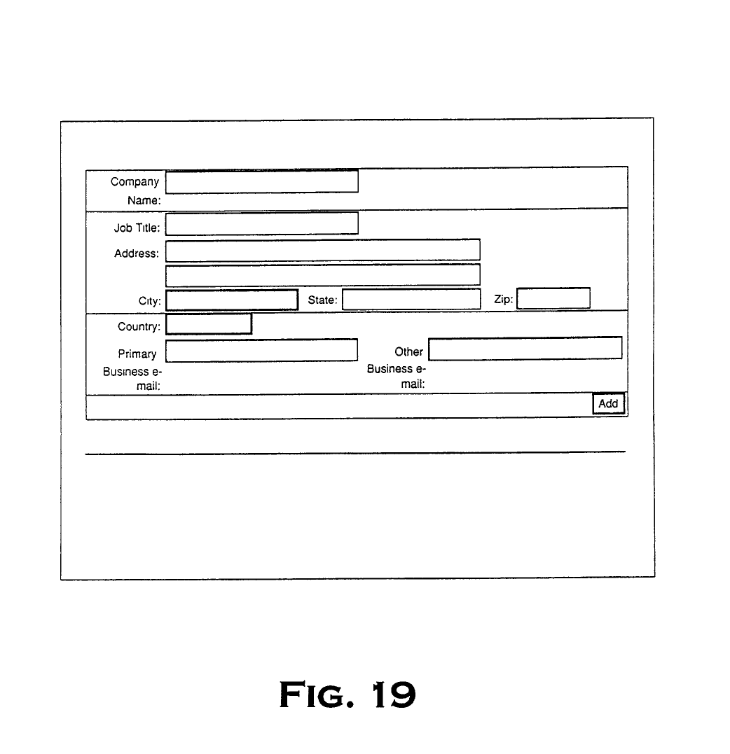

The contacts can be edited and new contacts may be added. FIGS. 18 and 19 show examples of screen views for adding contacts. The number of contacts per page may be adjusted as desired, such as 10 to 100, 5 to 20, etc. Contact lists may be also created or modified from blast results, may be presupplied, may be edited to eliminate duplicates, may be cleansed according to various criteria, etc. Tools for contact list management may be manual or automatic.

Returning to FIG. 2, a Greetings Management option is shown. The Greetings Management option, provides the user with various creation, editing and modification tools for greetings. In the preferred embodiments the user may create greetings in a number of ways, e.g., through uploading a sound file, generation of a sound file, having the system call the user for a greeting, etc. This latter option provides a more personable sounding message to the recipient.

A Message Manager, as well, is shown in FIG. 2. The Message Manager organizes messages left by recipients. For example voice mail accounts might be set up for survey results, customer service messages, offer acceptance, name and address information, requests for list removal, requests to reschedule a call, etc. As the blast proceeds, and messages are generated from the recipients, those messages are delivered to appropriate voice mail accounts. Thus, numerous individuals associated with the caller may receive messages from a blast in this embodiment. Additionally, any messages left by the recipient could be retrieved through a telephony interface, as well as through computer based interfaces. Additionally, transcription of voice messages is available, whether manually or automatically, through voice recognition. The Message Manager, in some embodiments, additionally includes a link to Contact List information for any particular recipient, so that, for example, a caller may, after receiving a message from a recipient, retrieve contact information about that recipient.

As seen in FIG. 2, there is also an Account Status screen available, which shows the particular user's account with the server's operator. Various embodiments may establish and maintain accounts differently. In some preferred embodiments, the users are billed on per blast basis, in other embodiments on a per call basis, in yet other embodiments, on a base plus features charge, in yet other embodiments on a reverse billing basis, etc. In yet other embodiments, the users may defer costs by partnering with the blast supplier, as well as by sharing information or encouraging others to provide recipients lists, etc. Additionally, “viral marketing” is useful in some embodiments, wherein the blast provider uses a blast to promote its services in the course of a blast. In such an embodiment, each call would stimulate more sales.

An Account Management screen is also provided, which is used to track various information such as caller telephone and billing information.

The preferred embodiments operate through a client/server architecture. The caller accesses the Website through a client machine. The Website is maintained through one or more applications servers, which generally provide an interface between the caller and one or more real-time call servers. Once the caller has prepared the program flow, provided any other desired variables for the calls, the server stores the information. The information is sent, when appropriate, to a call server. The call server proceeds to make the calls according to the entered variables. Transaction information, database tables, and other administrative information is maintained on the application server or servers. The real-time call servers are responsible for controlling to the telephony equipment which ultimately place the calls occurring during a blast.

Both application server and call server are, in the preferred embodiments, linked through numerous processes. For example, the application server constructs a number of tables containing call variable information. This information is then transmitted via a SQL agent process to a call server as desired. Of course, other embodiments may use alternative architectures, including but not limited to database technologies as known in the art, distributed processing architectures, etc.

It should be noted that, although the preferred embodiments utilize the telephone as the delivery instrument for a blast, other messaging alternatives might also be used, alone or in combination with a telephone interface. For example, an instant messaging delivery blast might be constructed through use of a directed program flow, similar to that described above with regard to telephone delivery, an interactive television blast might be constructed, SMS messaging might be used, etc.

It should be noted that the above description and the views and material depicted by the figures are for purposes of illustration only and are not intended to be, and should not be construed as, limitations on the invention.

Moreover, certain modifications or alternatives may suggest themselves to those skilled in the art upon reading of this specification, all of which are intended to be within the spirit and scope of the present invention as defined in the attached claims.

I claim:

1. A method for computerized telephone control, comprising the steps of:
accessing an interactive interface;
supplying values, in response to using said interactive interface;
creating a program flow, at least partially, from said supplied values; and,
using said program flow, at least in part, during a series of telephone calls by an automated calling means.

2. A method as in claim 1 further comprising the step of constructing a script from said program flow.

3. A method as in claim 1 further comprising the step of adding a greeting to said program flow.

4. A method as in claim 1 whereby the step of using said program flow, at least in part, during a series of telephone calls by an automated calling means further comprises using said script, at least in part, during said series of telephone calls.

5. A method as in claim 1 further comprising the step of human intervention during at least one of said series of telephone calls.

6. A method for computerized telephone control, comprising the steps of:
accessing an interactive interface, whereby said interactive interface requests responses to certain queries;
supplying responses to said queries;
creating a program flow, at least partially, from said supplied responses;
making at least one telephone call to a recipient by an automated calling means, and,
using said program flow, at least in part, during said at least one telephone call.

7. A method as in claim 6 further comprising repeating the steps of making at least one telephone call to a recipient by an automated calling means, and, using said program flow, at least in part, during said at least one telephone call.

8. A method as in claim 6 further comprising the step of constructing a script from said program flow.

9. A method as in claim 6 further comprising the step of constructing said program flow, at least in part, from preexisting program flow components.

10. A method as in claim 6 further comprising the step of constructing said program flow, at least in part, from a preexisting program flow template.

11. A method as in claim 6 further comprising the step of constructing said script, at least in part, from a preexisting script template.

12. A method as in claim 6 whereby the step of using said program flow during said at least one telephone call by an automated calling means further comprises using said script, at least in part, during said at least one telephone call.

13. A method as in claim 6 wherein the step of creating a program flow further comprises creating an interactive program flow.

14. A method as in claim 8 wherein the step of using said script, at least in part, during said at least one telephone call further comprises:
providing at least two alternative responses to said recipient to choose from in the course of said call; and,
providing at least two alternative actions in response to said recipient's choice of said at least two alternative responses.

15. A method as in claim 12 whereby said alternative actions are chosen from the group comprising: a response by a human, or, a response by an automated response unit.

16. A method as in claim 6 whereby the step of making at least one telephone call to a recipient by an automated calling means further comprises the step of identifying said recipient by using a list of potential recipients.

17. A method as in claim 16 whereby said list is created at least partially using feedback from at least one prior telephone call.

18. A method as in claim 17 whereby said list is edited at least partially using feedback from at least one prior telephone call.

19. A method as in claim 6 whereby the step of making at least one telephone call to a recipient by an automated calling means further comprises:
using a caller ID means for said call, whereby said caller ID means identifies a predetermined caller ID other than that of said automated calling means.

20. A method as in claim 6 whereby the step of making at least one telephone call to a recipient by an automated calling means further comprises making said at least one telephone call according to a predetermined schedule.

21. A method as in claim 6 whereby the step of making at least one telephone call to a recipient by an automated calling means further comprises making said at least one telephone call according to a schedule established by automated means.

22. A method as in claim 6 whereby the step of making at least one telephone call to a recipient by an automated calling means further comprises making said at least one telephone call according to an alterable schedule.

23. A method as in claim 6 further comprising the step of adding a greeting to said program flow.

24. A method as in claim 6 further comprising the step of recording the results of said call.

25. A method as in claim 22 further comprising the steps of:
of recording the results of said call; and,
using said results to alter said schedule.

26. A method as in claim 24 further comprising the step of using said results to modify said list.

27. A method as in claim 6 whereby the step of making at least one telephone call to a recipient by an automated calling means further comprises making more than one telephone call to more than one recipient.

28. A method as in claim 27 further comprising repeating the step of making more than one telephone call to more than one recipient.

29. A method as in claim 28 whereby the step of making more than one telephone call to more than one recipient further comprises making said calls on a predetermined schedule.

30. A method as in claim 28 whereby the step of making more than one telephone call to more than one recipient further comprises making said calls according to an alterable schedule.

31. A method as in claim 28 whereby the step of making more than one telephone call to more than one recipient further comprises making said calls on a predetermined schedule.

32. A method as in claim 31 whereby the step of making more than one telephone call to more than one recipient further comprises making only certain of said calls.

33. A method for computerized telephone control, comprising the steps of:
accessing an interactive interface, whereby said interactive interface requests responses to certain queries;
supplying responses to said queries;
creating a script, at least partially, from said supplied responses;
making a first series of telephone calls, which first series comprises at least one telephone call to a recipient by an automated calling means;
using said script during at said least one telephone call; and,
making a second series of telephone calls, initiated by predetermined criteria which second series comprises at least one telephone call.

34. A method as in claim 33 whereby said predetermined criteria comprises a request by said recipient of said first series.

35. A method for computerized telephone control, comprising the steps of:
accessing an interactive interface, whereby said interactive interface requests responses to certain queries;
supplying responses to said queries;
creating a first and a second script, at least partially, from said supplied responses;
attempting at least one telephone call to a predetermined recipient by an automated calling means; and,
determining whether, at the completion of the call circuit, a live recipient or an answering machine has received said call; and,
using said first script if a live recipient has received said call, or, using said second script if an answering machine has received said call.

36. A method for messaging, comprising the steps of:
accessing an interactive interface;
supplying values, in response to using said interactive interface;
creating a program flow, at least partially, from said supplied values; and,
using said program flow, at least in part, during a series of messages by an automated message means.

37. An apparatus for computerized telephone control, comprising an interactive interface means, used to create a program flow, wherein said program flow is used to create a script, and said script is used, at least in part, to guide a series of telephone calls made by an automated calling means.

38. An article of manufacture used in computerized telephone control, comprising a program flow created by an interactive interface means.

39. An article of manufacture used in computerized telephone control, comprising a script created by an interactive interface means.

40. An article of manufacture used in computerized telephone control, comprising a series of telephone calls, controlled at least in part, by a script created by an interactive interface means.
